(19) United States
(12) Patent Application Publication
(10) Pub. No.: US 2023/0375980 A1
(43) Pub. Date: Nov. 23, 2023

(54) Timepiece with drive for a rotary indicia ring

(71) Applicant: Time Grand Limited, Kwai Chung (HK)

(72) Inventors: Alexander Meerovitsch, Kwai Chung (HK); Yu Yan Chan, Kwai Chung (HK); Kei Hong Sandy Lee, Kwai Chung (HK)

(21) Appl. No.: 17/746,456

(22) Filed: May 17, 2022

(51) Int. Cl. G04B 19/28

(52) U.S. Cl. CPC G04B 19/283

(57) ABSTRACT

A drive for rotation of an indicia ring includes a bezel extending about the indicia ring and mounted to rotate about an axis. A transmission including a pair of gears that are coaxial and fixed to rotate together, with one engaging a toothed inner face of the indicia ring and the other engaging a tooth set of the bezel to thereby transmit torque from the bezel to the indicia ring. A detent is urged by resilient means to an extended position in which it is received between adjacent teeth. A locking member is mounted to the casing for movement between a locked position that blocks movement of the detent to its retracted position and an unlocked position that permits movement of the detent to its retracted position.

### TECHNICAL FIELD

The present invention relates to a timepiece comprising a rotary indicia ring and a drive by which the user may rotate the indicia ring.

### BACKGROUND OF THE INVENTION

In analogue timepieces it is known to provide an annular rotary indicia ring with an outer face that carries indicia relating to a time measurement and a toothed inner face, where a drive includes a thumbwheel (or a second crown) that turns a gear meshed with the toothed inner face to rotate the indicia ring. In such a drive the thumbwheel allows for fine angular adjustment and, as it is not readily turned unintentionally, mitigates the chance that inadvertent rotation of the indicia ring may occur. However, compared to more conventional rotary indicia rings which, for rotation, are adapted to be grasped directly by the user, this operation is less intuitive and is ergonomically unsatisfactory, particularly for dive watches where users may be wearing gloves, for example. Another drawback of this arrangement is that, owing to dimensional considerations, the thumbwheel is carried on a shaft that extends through an opening in the casing of the timepiece and, for dive watches exposed to high pressures, the ability to seal this opening can compromise the pressure rating of the timepiece. It is an object of the present invention to overcome or substantially ameliorate the above disadvantages or, more generally, to provide an improved timepiece.

### DISCLOSURE OF THE INVENTION

According to one aspect of the present invention there is provided a timepiece comprising:

a casing holding a movement;

an indicia ring supported on the casing and having an axis, the indicia ring including indicia and outer face opposite a toothed inner face, the indicia ring mounted to rotate about the axis;

a bezel extending about the indicia ring and mounted to rotate about the axis, the bezel carrying a tooth set;

a transmission comprising a pair of gears that are coaxial and fixed to rotate together, with one of the gears engaging the toothed inner face and the other of the gears engaging the tooth set to thereby transmit torque from the bezel to the indicia ring;

a detent urged by resilient means to an extended position in which it is received in a space between adjacent teeth of the tooth set or of the toothed inner face, the detent moveable to a retracted position outside the space, and

a locking member mounted to the casing for movement between a locked position that blocks movement of the detent to its retracted position and an unlocked position that permits movement of the detent to its retracted position.

Preferably the bezel is disposed at a periphery of the timepiece and the detent s received between adjacent teeth of the tooth set.

Preferably the locking member comprises a lever pivotally mounted to the casing. Alternatively, the locking member may be, for instance, a rotating or sliding latch.

Preferably teeth of the toothed inner face and the tooth set are contrate and the pair of gears are straight cut. Alternatively, the toothed inner face, the tooth set and the pair of gears may be bevel gears.

Preferably a common axis of the pair of gears extends radially relative to the axis of the indicia ring.

Preferably the transmission is mounted to slide in the direction of the common axis while the pair of gears remain meshed with teeth of the toothed inner face and the tooth, the locking member comprises a cam that abuts the pair of gears to displace them radially inward in the locked position and a resilient device that is compressed in the locked position and urges the pair of gears toward the cam.

Preferably the pair of gears are joined by a shaft received in an opening in the casing, and the resilient device comprises an elastomeric ring around the shaft that seals the opening.

Preferably the timepiece further comprises a crystal and a fixed ring surrounding that crystal and fixed to the casing, the fixed ring comprising twelve hour-indicating indicia, and wherein the bezel surrounds the fixed ring.

This invention thus provides a drive for turning a rotary indicia ring that, by using a rotary bezel for this purpose, can be readily operated in an intuitive manner, even with gloved hands. Moreover, the compressed elastomeric ring provides better sealing of the movement for an increased pressure rating.

### BRIEF DESCRIPTION OF THE DRAWINGS

Preferred forms of the present invention will now be described by way of example with reference to the accompanying drawings, wherein:

FIG. 1 is a pictorial view, from the front, of a timepiece according to a preferred embodiment of the invention;

FIG. 2 is a partially exploded view of the timepiece of FIG. 1;

FIG. 3 is a fragmentary view, from the rear, of the indicia ring and bezel of the timepiece of FIG. 1;

FIG. 4 is a fragmentary section through the timepiece of FIG. 1 in an axial-radial plane that intersects the detent;

FIG. 5 is a fragmentary section through the timepiece of FIG. 1 in an axial-radial plane that intersects the transmission, and

FIG. 6 is a fragmentary view, from the front, of the proximal end of the locking lever.

### DESCRIPTION OF THE PREFERRED EMBODIMENTS

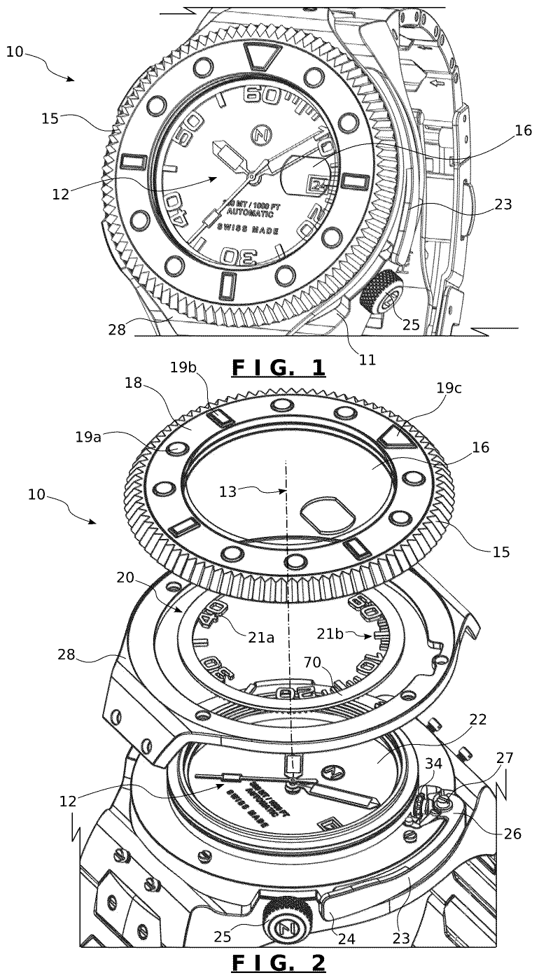

Referring to FIGS. 1 and 2, an analogue timepiece 10 comprises a casing 11 holding a movement 14 (see FIG. 4) that rotates hands 12 about an axis 13. As used herein, except where the context requires a different meaning, the term “axial” refers to a direction substantially parallel to the axis 13. The term “radial” refers to a direction substantially orthogonal to the axis 13. The term “circumferential” refers to the direction of a circular arc having a radius substantially orthogonal to the axis 13.

A bezel 15 that is annular and surrounds the crystal 16 at the periphery of the timepiece is mounted to the casing 11 to rotate about the axis 13. The outer edge of the bezel may comprise a ribbed frustoconical surface 17 allowing it to be grasped in a non-slip manner. A ring 18 may be provided fixed to the casing 11, as by an interference fit, and disposed generally between the bezel 15 and the crystal 16. The ring 18 may carry indicia such as decorative pieces 19a, 19b, 19c on its outer face disposed in a circular array and equally angularly spaced, and particularly comprising twelve hour-indicating indicia which are thus disposed radially outboard of the hands 12.

An indicia ring 20 is supported on the casing 11 to rotate about the axis 13 and its outer face is visible in FIG. 2. The indicia ring 20 carries circumferentially spaced indicia 21a, 21b which may indicate minutes. The indicia ring 20 may be disposed axially outside the hands 12 and may be sized such that the tips of the longer ones of the hands sweep below the indicia 21. The indicia 21a may comprise numerals integrally formed with the indicia ring 20. The indicia ring 20 may comprise an outer portion 70 with a thickness extending in the axial direction and a generally rectangular cross-section (in an axial-radial plane) and with which the indicia 21a, 21b are integral, projecting from an inner circumference of the indicia ring 20 and having substantially the same thickness as the outer portion 70. The indicia 21a, 21b may thus provide visually significant “depth” that distinguishes them from indicia that are merely marked or formed on the outer face of the indicia ring. In this manner, the array of fixed hour-indicating indicia surround the rotating indicia 21a, 21 in a configuration which is the opposite to that of conventional dive watches or timepieces of this type.

A dial 22 disposed axially inwardly of the indicia ring 20 and the hands 12 lacks any angularly spaced indicia, providing a clear, unambiguous time display.

A locking lever 23 may be arcuate and elongated to extend along the right side of the timepiece 10, with a distal end 24 that, in the closed position, lies adjacent the crown and a proximal end 26 connected by a screw 27 for rotation of the locking lever 23 generally parallel to the axis 13. In FIG. 2, a casing plate 28 that covers the screw 27 is shown in an exploded position where it is displaced axially outwardly to better expose the underlying locking lever 23.

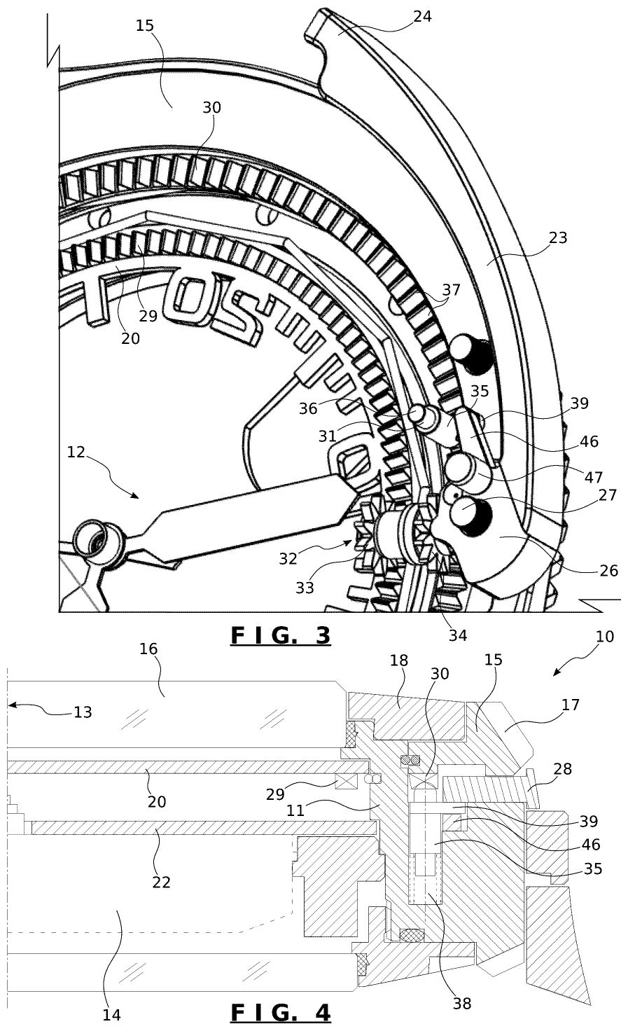

As best seen in FIGS. 3 and 4, the indicia ring 20 has a toothed inner face 29 and the bezel 15, which extends about the indicia ring 20, has a tooth set 30 on its inner side.

The toothed inner face 29 and tooth set 30 are generally disposed in the same radial plane. A transmission 32 transmits torque from the bezel 15 to the indicia ring 20 and comprises a pair of gears 33, 34 that are coaxial and fixed to rotate together, with the gear 33 engaging the toothed inner face 29 and the gear 34 engaging the tooth set 30.

A detent 31 ensures that the bezel 15 is indexed in equal steps corresponding to the pitch of teeth of the tooth set 30 and may have a cylindrical central portion 35 received in a complementary opening in the casing 11 to guide it to reciprocate linearly parallel to the axis 13. One axial end 36 of the detent 31 engaging the tooth set 30 may be domed whereby it moves smoothly between the extended position in which it is received in a space 37 between adjacent teeth of the tooth set 30 and a retracted position (not shown) outside the space. A helical compression spring 38 may abut the other end of the detent 31 and urge it to the extended position. Projecting from a side of the detent 31 is a stop 39 that, in the manner described below, limits the retraction of the detent 31 to lock the bezel 15 against rotation.

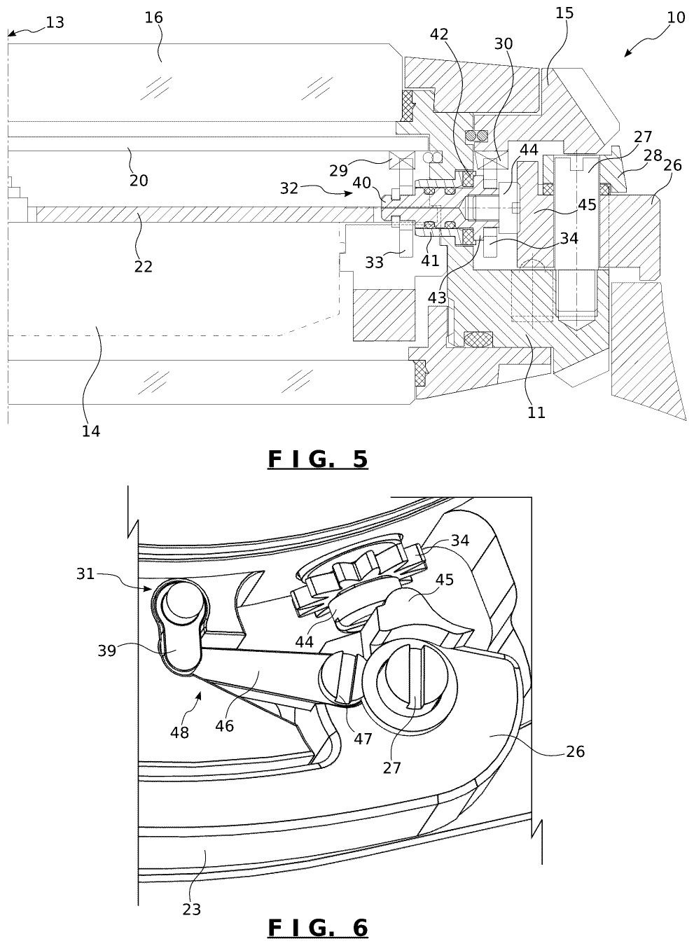

Referring to FIGS. 5 and 6, the transmission 32 may be an assembly comprising a shaft on which the gears 33, 34 are fixed, as by an interference fit. A radially aligned cylindrical sleeve 41 may be fixed in the casing 11 with a complementary length of the shaft 40 received in the sleeve 41, thereby supporting the shaft 40 both for rotation about a radial axis and displacement in the radial direction. An elastomeric ring 42 sealingly extends around the shaft 40 and may be held between an axial end of the sleeve 41 and a shoulder 43 formed on the shaft and in this manner tends to urge the shaft 40 radially outwardly. A screw 44 may be fixed in an axial threaded aperture in an outer end of the shaft 40. The screw 44, by the resilient action of the elastomeric ring 42 is urged against a lobe of a cam 45 formed on the proximal end 26 of the locking lever 23.

An arm 46 may be pivotably coupled at one end to the proximal end 26 by a screw 47 aligned parallel with axis 13. The free end of the arm 46 may project into a channel 48 formed in the casing that tapers to narrow toward the stop 39. The slot channel thus serves to guide the free end of the arm 46 to the position shown when the locking lever 23 is closed or moved to its locked position. In the locked position, the free end of the arm 43 abuts the stop 39 fixed on the detent 31 and thereby blocks movement of the detent 31 to its retracted position.

The locking lever 23 may be initially in the locked position illustrated and to set the indicia ring 20 to a desired angular position, the user first pulls the distal end 24 away from the timepiece 10 while rotating the locking lever 23. As the cam 45 rotates pressure on the elastomeric ring 42 is released and the transmission 32 is displaced radially outwardly. In the unlocked position, the movement 14 remains sealed by the elastomeric ring 42, although with a reduced degree of ingress protection. The displacement of the transmission 32 is facilitated by the teeth of the toothed inner face 29 and the tooth set 30 being contrate while the pair of gears 33, 34 are straight cut so the meshed engagement is maintained during this radial movement. Simultaneously, during rotation, the tip of the arm 43 is withdrawn from the narrow end of the channel 48 and out the position where it blocks axial movement of the stop 46, thereby unlocking the detent 31 and freeing it to reciprocate as the bezel 15 is turned. The bezel 15 can be readily grasped, even with a gloved hand, and rotated to turn the indicia ring 20. A complete rotation of the bezel 15 may comprise 120 equally spaced detent positions, corresponding to 120 teeth in the tooth set 30. Once set in this way, the locking lever 23 is returned to its locked position, locking the detent 31, and preventing any inadvertent rotation of the bezel 15.

Aspects of the present invention have been described by way of example only and it should be appreciated that modifications and additions may be made thereto without departing from the scope thereof.

1. A timepiece comprising:
a casing holding a movement;
an indicia ring supported on the casing and having an axis, the indicia ring including indicia and an outer face opposite a toothed inner face, the indicia ring mounted to rotate about the axis;
a bezel extending about the indicia ring and mounted to rotate about the axis, the bezel carrying a tooth set;
a transmission comprising a pair of gears that are coaxial and fixed to rotate together, with one of the gears engaging the toothed inner face and the other of the gears engaging the tooth set to thereby transmit torque from the bezel to the indicia ring;
a detent urged by resilient means to an extended position in which it is received in a space between adjacent teeth of the tooth set or of the toothed inner face, the detent moveable to a retracted position outside the space, and
a locking member mounted to the casing for movement between a locked position that blocks movement of the detent to its retracted position and an unlocked position that permits movement of the detent to its retracted position.

2. The timepiece of claim 1 wherein the bezel is disposed at a periphery of the timepiece and the detent is received between adjacent teeth of the tooth set.

3. The timepiece of claim 1 wherein the locking member comprises a lever pivotally mounted to the casing.

4. The timepiece of claim 1 wherein teeth of the toothed inner face and the tooth set are contrate and the pair of gears are straight cut.

5. The timepiece of claim 1 wherein a common axis of the pair of gears extends radially relative to the axis of the indicia ring.

6. The timepiece of claim 1 wherein the transmission is mounted to slide in the direction of the common axis while the pair of gears remain meshed with teeth of the toothed inner face and the tooth, the locking member comprises a cam that abuts the pair of gears to displace them radially inward in the locked position and a resilient device that is compressed in the locked position and urges the pair of gears toward the cam.

7. The timepiece of claim 1 wherein the pair of gears are joined by a shaft received in an opening in the casing, and the resilient device comprises an elastomeric ring around the shaft that seals the opening.

8. The timepiece of claim 1 further comprising a crystal and a fixed ring surrounding that crystal and fixed to the casing, the fixed ring comprising twelve hour-indicating indicia, and wherein the bezel surrounds the fixed ring.
